(19) United States
(12) Patent Application Publication
(10) Pub. No.: US 2023/0206571 A1
(43) Pub. Date: Jun. 29, 2023

(54) SYSTEM AND METHOD FOR SYNCING LOCAL AND REMOTE AUGMENTED REALITY EXPERIENCES ACROSS DEVICES

(71) Applicant: Busker AR, Inc., Golden, CO (US)

(72) Inventors: Gabriel Darling, Jersey City, NJ (US); Andrew Zeneski, Lakeville, PA (US); Peter Calfee, Englewood, CO (US)

(73) Assignee: Busker AR, Inc., Golden, CO (US)

(21) Appl. No.: 18/088,441

(22) Filed: Dec. 23, 2022

Related U.S. Application Data
(60) Provisional application No. 63/294,811, filed on Dec. 29, 2021.

(51) Int. Cl. G06T 19/00; H04L 67/131; H04L 67/1095; G06F 1/16

(52) U.S. Cl. CPC G06T 19/006; H04L 67/131; H04L 67/1095; G06F 1/1637

(57) ABSTRACT

Provided are a system and method for syncing local and remote augmented reality experiences across user devices. The system utilizes a User's hand held portable computing device (PCD) having at least a camera, a touch screen display, and a position determining systems. The system adapts the User's hand-held PCD with a software application, the software application enabling the hand-held PCD to process a video stream to identify a reference element within the User's real space as perceived by the camera. The software application also determines the location and orientation of the User's hand-held PCD with respect to the reference object. With a reference object defined, the User's real space is virtualized as a local space displayed on the PCD display. The User's location and position with respect to the reference element is shared with a remote computer system which disseminates the data to other Users, each User's PCD mapping the other remote User's location and position with respect to the reference element such that users perceive an augmented reality experience. Users may also indicate the location of virtualized objects that are shared with other Users. A method of use is also disclosed.

### CROSS REFERENCE TO RELATED APPLICATIONS

This application claims the benefit under 34 U.S.C. § 119(e) of U.S. Provisional Application No. 63/294,811 filed Dec. 29, 2021 and entitled SYSTEM AND METHOD FOR SYNCING LOCAL AND REMOTE AUGMENTED REALITY EXPERIENCES ACROSS DEVICES, the disclosure of which is incorporated herein by reference.

### FIELD OF THE INVENTION

The present invention relates generally to sharing augmented reality experiences across computing devices, and more specifically to a system and method synchronizing those shared augmented reality experiences in real time.

### BACKGROUND

With the advent of mobile computing, new technologies and methodologies have enabled unique opportunities for new interactions between people. Augmented reality is one technology that has applications in communication, entertainment, business collaboration, gaming and many other areas.

In some embodiments, augmented reality uses a person's mobile computing device, and more specifically the device's camera, accelerometers and processors to display virtual objects in the camera feed of that device. It maps the objects onto the real world through a system of heuristic identification of planes and objects. These planes and objects are held and tracked as references to their real-world counterparts.

In a typical augmented reality experience, each element's tracking is handled locally on the user's computing device, thus the experience is particular to that local space, and even more so—particular to the specific device. In order to share an augmented reality experience across devices, each device would need to share and agree upon this tracked data.

Furthermore, to share the experience in real time requires the devices to constantly update and synchronize these tracked and virtualized elements. This means there are limitations on how we can share experiences both in proximity (the distance between devices for the transmission of data, if not a requirement that the users be in the same local physical space), and in participant volume (the total number of people who may actually participate in such an augmented reality at any given time).

Methods for small scale, local, device to device synchronizing on specific platforms, but currently, there exists no platform-agnostic, broadly scalable method for synchronizing shared augmented reality experiences in combined local and remote spaces, as well as for a large number of people. Further still, as there are a wide number of options for portable computing devise—i.e., smart phones, different versions and models often provide wide variation in computing power and resources.

Hence there is a need for a method and system that is capable of overcoming one or more of the above identified challenges.

### SUMMARY OF THE INVENTION

Our invention solves the problems of the prior art by providing novel systems and methods for synchronizing augmented reality experiences in real time for devices in shared local and remote spaces.

In particular, and by way of example only, according to at least one embodiment, provided is a system for synchronizing augmented reality experiences between at least two people, including: a first hand held computing device held out by a first user, the first portable computing device including: a first camera; a first touch display; a first position determining system; a first transceiver structured and arranged to exchange digital data with at least one remote computer system; a first processor; a first non-volatile memory coupled to the first processor having a first instance of an Augmented Reality Application (ARA) presenting processor executable instructions to direct the operation of at least the first camera, the first touch display, the first position determining system, and the first transceiver to obtain from the first camera a first image of the first user's local space and generate a first virtualized local space, the first processor defining a first reference element within the first image and first virtualized local space and initializing the first user's location and orientation with respect to the first reference element; wherein at least the first virtualized local space, the first reference element and the first user's location and orientation are provided to the at least one remote computer system, the first reference element mapped by the at least one remote computer system to an origin Virtualized Reference Element with the first use's location and orientation indicating a first avatar position; a second hand held computing device held out by a second user, the second portable computing device including: a second camera; a second touch display; a second position determining system; a second transceiver structured and arranged to exchange digital data with the at least one remote computer system; a second processor; a second non-volatile memory coupled to the second processor having a second instance of the ARA presenting processor executable instructions to direct the operation of at least the second camera, the second touch display, the second position determining system, and the second transceiver to obtain from the second camera a second image of the second user's local space and generate a second virtualized local space, the second processor defining a second reference element within the second image and second virtualized local space and initializing the second user's location and orientation with respect to the second reference element; wherein at least the second virtualized local space, the second reference element and the second user's location and orientation are provided to the at least one remote computer system, the second reference element mapped by the at least one remote computer system to the origin Virtualized Reference Element with the second use's location and orientation indicating a second avatar position; wherein the first avatar position relative to the origin Virtualized Reference Element and the second avatar position relative to the origin Virtualized Reference Element is continuously revised and shared as digital information transmission between the at least one remote computer system, the first hand held computing device and the second hand held computing device, the origin Virtualized Reference Element permitting the first hand held computing device to generate and display continuously revised presentations the second avatar in the first virtualized local space and the second hand held computing device to generate and display continuously revised presentations of the first avatar in the second virtualized local space as an augmented reality space.

For yet another embodiment, provided is a system for synchronizing augmented reality experiences between at least two people, including: a remote server system having a processor and a digital database, the digital database having a user account for each user utilizing an instance of an application for augmented reality, each user account including at least each user's last known location and orientation with respect to a reference element as defining a virtualized local space for each user as virtualized user digital data; an Augmented Reality Application (ARA) for installation upon a user's hand-held computing device to be hand held by the user during an augmented reality session, the ARA having at least: a virtualized local space generator structured and arranged to generate from an image of the user's environment the virtualized local space and the reference element within the image of the user's environment and the virtualized local space; a virtual object generator structured and arranged to generate at least one virtualized object within the virtualized local space with respect to the virtualized reference element; a mapper structured and arranged to map the reference element from a local instance of the ARA to the reference element from a remote instance of the ARA, the mapper thereby aligning the virtualized local space of the local instance of the ARA with the virtualized local space of the remote instance of the ARA; a digital data exchanger structured and arranged to exchange at least virtualized user digital data with at least the remote server system; wherein a local user desiring an augmented reality experience provides a hand held computing device having at least a processor with memory resources, a camera, a touch display, a position determining system, and a transceiver, an instance of the ARA adapting the processor to generate the virtualized local space and the virtualized reference element, the ARA adapting the processor to obtain from the remote server at least the virtualized user digital data of at least one remote user, the virtual object generator and mapper enabling the processor to generate and provide to the touch display a presentation of the local virtualized local space and the remote virtualized local space as an augmented reality space, the ARA further directing the local user's hand held device to continuously revise the presentation of the augmented reality space as the local user and remote user positions change relative to the mapped virtualized reference elements.

And for yet another embodiment, provided is a method for synchronizing augmented reality experiences between at least two people, including: obtaining on a first hand held computing device held out by a first user a first image of the first user's local space; generating a first virtualized local space based on the first image and defining a first reference element; determining the first user's location and orientation relative to the first reference element; sharing at least the first reference element and the first user's location and orientation as virtualized first user digital data with at least one remote server system having a processor and a digital database; obtaining on a second hand held computing device held out by a second user a second image of the second user's environment; generating a second virtualized local space based on the second image and defining a second reference element; determinizing the second user's location and orientation relative to the second reference element; sharing at least the second reference element and the second user's location and orientation as virtualized second user digital data with the at least one remote server system; receiving upon the second hand held computing device from the at least one remote server system the virtualized first user digital data, the second hand held computing device mapping the second reference element to the first reference element to align the second virtualized local space to at least a portion of the first virtualized local space with a first avatar of the first user presented based on the first user's location and orientation; receiving upon the first hand held computing device from the at least one remote server system the virtualized second user digital data, the first hand held computing device mapping the first reference element to the second reference element to align the first virtualized local space to at least a portion of the second virtualized local space with a second avatar of the second user presented based on the second user's location and orientation; wherein the first hand held computing device and the second hand held computing device exchange first user location and orientation and second user location and orientation information to continuously revise presentations of the first virtualized local space and the second virtualized local space as an augmented reality space and the first avatar and the second avatar relative to the first reference element.

### BRIEF DESCRIPTION OF THE DRAWINGS

FIG. 1 is a high-level overview diagram of a Synchronized Augmentation System (“SAS”) in accordance with at least one embodiment;

FIG. 2 is a high-level overview of how SAS achieves synchronization in accordance with at least one embodiment;

FIGS. 3A, 3B and 3C are illustrations and conceptualizations of the augmented reality application (ARA) performing element identification in accordance with at least one embodiment;

FIGS. 4A, 4B and 4C are illustrations exemplifying determination of a reference element in each virtualized local space accordance with at least one embodiment;

FIGS. 5A, 5B and 5C are illustrations exemplifying a scaling factor for each virtualized local space in accordance with at least one embodiment;

FIG. 6 is a conceptual top view of the virtualized local spaces in FIGS. 5A-5C, in accordance with at least one embodiment;

FIGS. 7A, 7B, 7C and 7D are state diagrams for SAS in accordance with at least one embodiment;

FIG. 8 is a conceptual illustration of a client network in SAS in accordance with at least one embodiment;

FIG. 9 is a flow diagram for a method of achieving SAS in accordance with at least one embodiment;

FIG. 10 is a high level conceptualized diagram illustrating a plurality of segregated client networks within SAS in accordance with at least one embodiment; and

FIG. 11 is a high-level block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for synchronizing augmented reality experiences. Thus, although the instrumentalities described herein are for the convenience of explanation shown and described with respect to exemplary embodiments, it will be understood and appreciated that the principles herein may be applied equally in other types of systems and methods involving synchronizing augmented reality experiences.

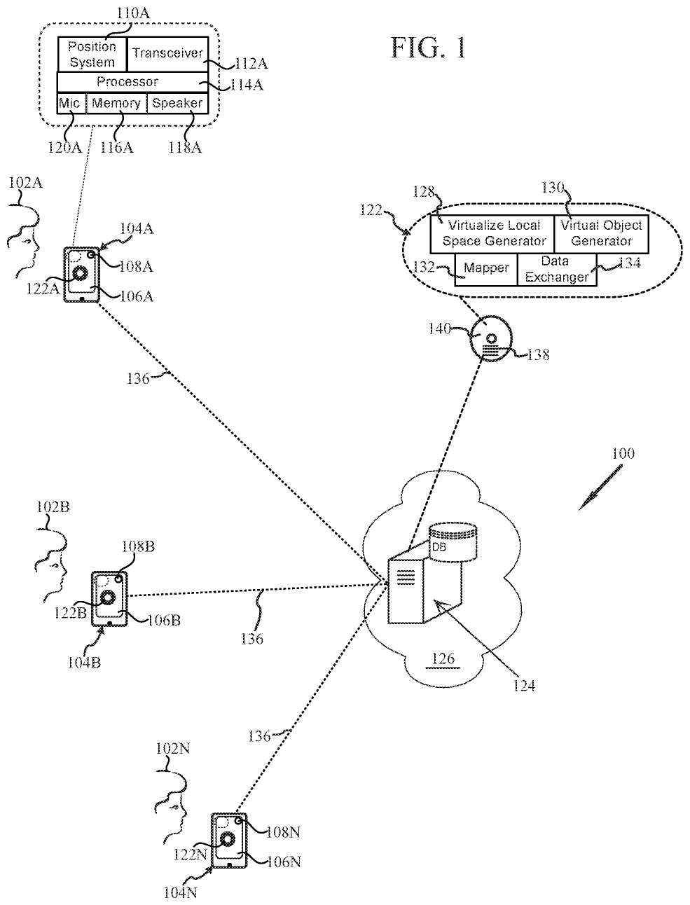

This invention is described with respect to preferred embodiments in the following description with references to the Figures, in which like numbers represent the same or similar elements. It will be appreciated that the leading values identify the Figure in which the element is first identified and described, e.g., element 100 first appears in FIG. 1.

Various embodiments presented herein are descriptive of apparatus, systems, articles of manufacturer, or the like for systems and methods for the synchronizing of local and remote augmented reality experiences across at least two human user portable computing devices.

Moreover, some portions of the detailed description that follows are presented in terms of the manipulation and processing of data bits within a computer memory. The steps involved with such manipulation are those requiring the manipulation of physical quantities. Generally, though not necessarily, these quantities take the form of electrical or magnetic signals capable of being stored, transferred, combined, compared and otherwise manipulated.

Those skilled in the art will appreciate that these signals are commonly referred to as bits, values, element numbers or other clearly identifiable components. Further still, those skilled in the art will understand and appreciate that the transfer of data between user computing devices is transfer of digital data, and that such data is most typically transferred in the form of electronic radio frequency signals.

It will also be appreciated that as an augmented reality experience is a combination of real and computer generated elements, such as but not limited to visual elements, for at least one embodiment the visual augmented reality elements are presented to a human user by way of a computer operated video display screen, which is presenting to the human user a combination of real world images captured from the user's immediate physical environment with computer generated elements disposed therein. In other words, a computer system is directing the rendering, placement and movement of the virtualized object into the visual space of the human user's visual environment in real time.

Moreover, it will be understated and appreciated that digital data, the radio frequency transmission of digital data, and the utilization of the digital data for the rendering images on electronic display screen in real time are actions and abilities that cannot be performed by a person or the human mind.

It is of course understood and appreciated that all of these terms are associated with appropriate physical quantities and are merely convenient labels applied to these physical quantities. Moreover, it is appreciated that throughout the following description, the use of terms such as “processing” or “evaluating” or “receiving” or “outputting” or the like, refer to the action and processor of a computer system or similar electronic computing device that manipulates and transforms the data represented as physical (electrical) quantities within the computer system's memories into other data similarly represented as physical quantities within the computer system's memories.

The present invention also relates to an apparatus for performing the operations herein described. This apparatus may be specifically constructed for the required purposes as are further described below, or the apparatus may be a general-purpose computer selectively adapted or reconfigured by one or more computer programs stored in the computer upon computer readable storage medium suitable for storing electronic instructions.

Indeed, for at least some embodiments of the present invention, it is a highly advantageous feature of the present invention to adapt a user's existing mobile computing device to synchronize local and remote augmented reality experiences without requiring the user to acquire a specific and dedicated computing device for such purposes.

To further assist in the following description, the following defined terms are provided.

“User”—a person who is known to the reality augmentation system and who is in communication with, and participating with the augmentation system and other Users through the use of an adapted portable computing device, aka PCD.

“Portable Computing Device” or “PCD”—Each portable computing device is understood and appreciated to provide at least a camera, a touch display, a position determining system, a transceiver or the exchange of data with at least one remote computing system, at least a processor, and non-volatile memory coupled to the processor. Each portable computing device will most likely also provide at least one speaker and at least one microphone. For embodiments of the present invention, the augmentation of reality is truly performed in a very fluid way with a User simply holding and moving his or her PCD, such as, but not limited to a hand held computing device, such as a smartphone such as an iPhone®, iPad®, Android®, smart watch or another similar device.

“Reference Element” or “RE”—An element visually apparent in an image of a User's local, real-world environment (physical local space) that is identified by the synchronized augmentation system—such as a plane (wall, floor, ceiling, top of chair/table/desk, or a known object identified by comparison to a database of known objects—plant/window/lamp/etc. . . . ). Moreover, the Reference Element is a static element, as in not a moving element, that can be determined and understood to have an essentially fixed location within the User's real world, such a corner point between walls and the floor or ceiling, or the plane as defined by the top of a chair, table, desk, chair, bookcase, sofa, etc. . . . . The reference object may also be determined to be a known object, such as a window, pot for a plant, lamp, or other object which has been recorded as a digitized object for digital comparison and identification. As will be more fully described below, the Reference Element provides a point of reference within each User's augmented reality space. Simply put, if two Users were in the same room on opposite sides of a table upon which was a statue of a man, each User would have a different visual appreciation of the statue of the man given their respectively different locations in the room. For this real-world example, the table top is a common Reference Element. In the synchronized augmentation system, each User's unique Reference Element is mapped to the other such that virtualized objects—e.g., an image of the statue of the man, is presented to each User with appropriate orientation and depiction based on their location and orientation in respect to each User's Reference Element and how they are mapped to each other.

“Virtual Object”—Virtual Objects are those elements which are not physically present in the User's physical real-world environment, but which are visually added to the video image as presented to a User by his or her PCD in accordance with the synchronized augmentation system. Virtual Objects may be static or animated image elements, and may appear as actual representations of real-world elements, bowl, cup, chair, etc. . . . which are essentially indistinguishable from other images of real-world elements, or they may be obvious computer rendered elements based as cartoon elements, caricatures, fantasy, video stream, or other renderings, e.g., a confetti cannon, smiling rain cloud, slide show presentation, etc. . . . . A Virtual Object may also be an avatar of another User, so a first User may appreciate the virtualized apparent location of another User within the augmented reality space as visually presented.

Turning now to the figures, and more specifically FIG. 1, there is shown a high-level diagram of an embodiment of the synchronized augmentation system 100, hereinafter SAS 100, for synchronizing augmented reality experiences between at least two people, aka Users 102. More specifically, as shown there are Users 102 each having a PCD 104.

Each PCD 104 has at least display 106, a camera 108, a position determining system 110 (such as but not limited to a GPS and/or accelerometer), a transceiver 112 for the exchange of digital data with at least one remote computing system, at least one processor 114, and non-volatile memory 116 coupled to the at least one processor 114. Each PCD 104 will most likely also provide at least one speaker 118 and at least one microphone 120. The display 106 may also be a touch screen display 106, understood and appreciated as a device upon which the user can tap, touch or draw with a finger or physical indicator to provide User input data. Indeed, as used throughout this application, it will be understood and appreciated that the display 106 is indeed a touch display 106. The PCD 104 may also have a plurality of cameras 108, such as at least one rear facing and one forward facing camera 108.

For at least one embodiment, interaction/participation with SAS 100 is facilitated by each PCD 104 having an app 122 (e.g., the Augmented Reality App or “ARA 122”) which adapts each PCD 104 for interaction with a remote computer system 124 and other App adapted PCD 104 devices in use by other Users 102. As will be further described below, the remote computer system 124, which may also be described as a computer server, supports a client network 126 for managing updates to Users 102 of the shared experiences across all PCDs 104 that are participating with the client network 126.

With respect to FIG. 1, for the present example there are shown a plurality of Users 102, of which User 102A, 102B and 102N are exemplary. Each user 102A-102N has a corresponding PCD 104, of which PCD 104A-104N are exemplary. Further, Each PCD 104A-104N has an instance of the ARA 122, of which ARA 122A-122N are exemplary.

As will be more fully appreciated below, each active instance of ARA 122 adapts each PCD 104 by providing at least a virtualize local space generator 128, a virtual object generator 130, a mapper 132 and a data exchanger 134. Typically, ARA 122 will rely upon existing base system hardware and software for the operation of the PCD 104 camera, microphone, touch display, location system, and transceiver.

In simple terms, the virtualize local space generator 128 is structured and arranged to generate from an image of the user's local space (their physical real-world environment), a virtualized local space and a reference element within the image of the user's local space and the virtualized local space. As is discussed below, the reference element is used to relate the real-world local space and the virtualized local space for a given User 102, the virtualized reference element providing a reference point to which the location of the User 102, perceived as the location of his or her PCD 104 is in relation to the reference element.

The virtual object generator 130 is structured and arranged to generate at least one virtualized object within the virtualized local space with respect to the virtualized reference element. And the mapper is structured and arranged to map the virtualized reference point from a local instance of the ARA 122 (that of a first User 102A) to the reference element from a remote instance of the ARA 122 (that of a second User 102B), the mapper thereby aligning the virtualized local space of the local instance of the ARA 122 with the virtualized local space of the remote instance of the ARA 122.

For scalability to provide a shared augmented reality space to a plurality of Users 102, as is further described below, the virtualized reference elements of each users virtualized local space are mapped by the mapper 132 and stored by the remote computer system 124, such that all users are provided with essentially the same mapping of the virtualized environment. With such centralized recording, updating and transmission back to the PCDs 104 the cohesiveness of the virtual environment is maintained and whether physically close or distant, different Users 102 share and experience a harmonized virtual environment.

With respect to this centralized mapping of virtualized reference elements, for at least one embodiment the mapper 132 as an element of each ARA 122 assists with the localized operation of determining the location and scale of the virtual objects generated by the virtual object generator 130.

In various embodiments ARA 122 may be a robust application, meaning that it is largely self-sufficient for conducting and controlling operation of the PCD 104 upon which it is installed. However, in many embodiments of SAS 100, while the ARA 122 may be quite robust and capable of many operations autonomously, it may also be configured to utilize resources of the remote computer system 124 for at least some computer processing and data analysis operations such as, but not limited to, the identification of objects within images by comparison to a database of object images.

As is conceptually illustrated by dotted lines, each PCD 104 is enabled for network communication 136, such as by wireless network communication 136, and therefore may establish digital data exchange with at least one remote computer system 124 and at least one other User 102 of SAS 100.

With respect to FIG. the elements of the ARA 122 (the virtualize local space generator 128, the virtual object generator 130, the mapper 132 and the data exchanger 134) are conceptually illustrated in the context of an embodiment for at least one computer program 138. Such a computer program 138 may be provided upon a non-transitory computer readable media, such as an optical disc 140 or USB drive (not shown), having encoded thereto an embodiment of the program for ARA 122.

Moreover, the computer executable instructions for computer program 138 regarding ARA 122 may be provided to the remote computer system 124, which in turn provides computer program 138 as digital information to each PCD 104. For at least one alternative embodiment, computer program 138 for ARA 122 is made available from a third party such as, but not limited to the Apple® App Store, or Google® Play, or such other third-party application provider. And for yet another embodiment, the embodiment, computer program 138 for ARA 122 may be separately provided on a non-transitory computer readable media for upload to such a third-party application provider or even to User 102 directly for direct installation upon his or her PCD 104.

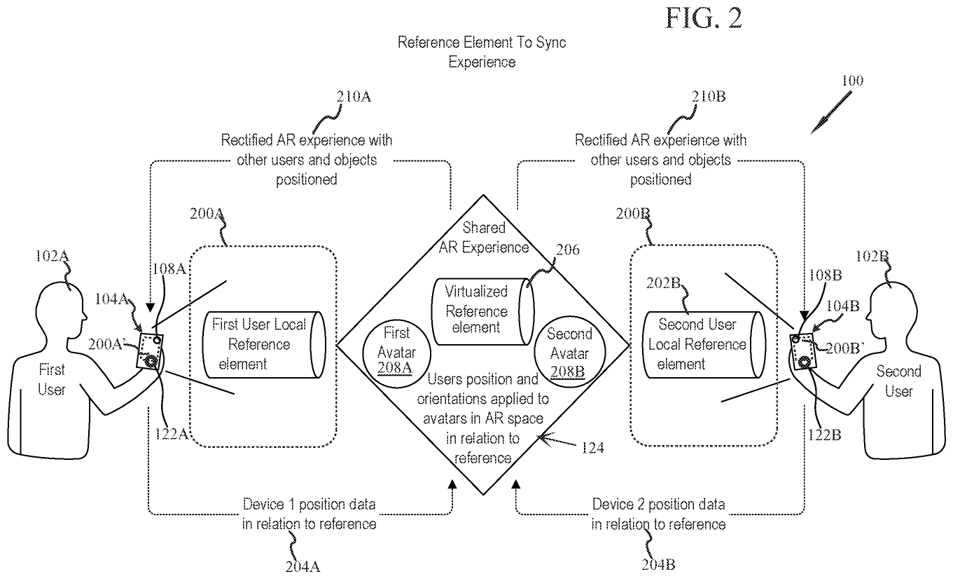

To briefly summarize, SAS 100 provides a system and method that permits two more computing device, e.g., PCDs 104, to synchronize shared augmented reality experiences both locally and remotely. FIG. 2 is provided to provide a high-level conceptualization of how at least one embodiment of SAS 100 advantageously achieves this synchronize shared augmented reality experience.

For ease of illustration and discussion, FIG. 2 has been rendered with just two Users—first User 102A and second User 102B, but it will be understood and appreciated that the described methodology and system operation may be extrapolated to potentially any number of Users 102.

First User 102A has an instance of ARA 122A installed on his/her PCD 104A, and second User 102B had an instance of ARA 122B installed on his/her PCD 104B. For at least one embodiment, ARA 122A utilizes various Software Development Kits (SDKs), such as, but not limited to Unity Engine, Photon PUN services, Agora RTC services, Amazon Web Services and custom code and APIs.

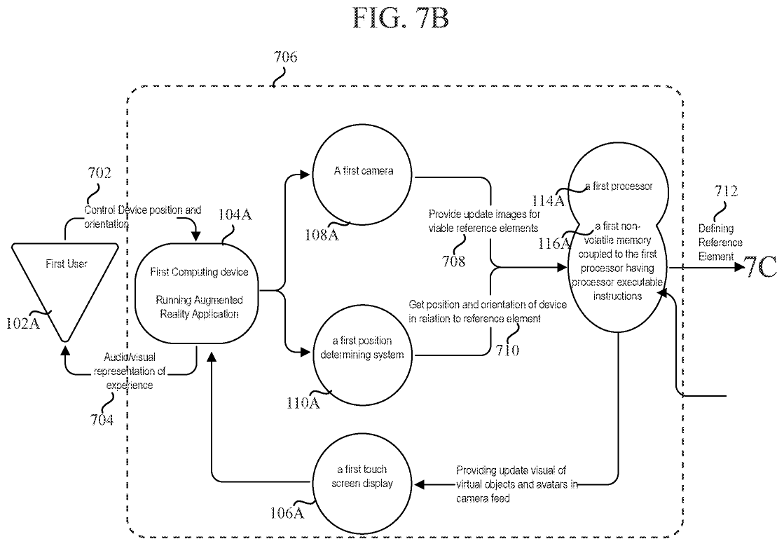

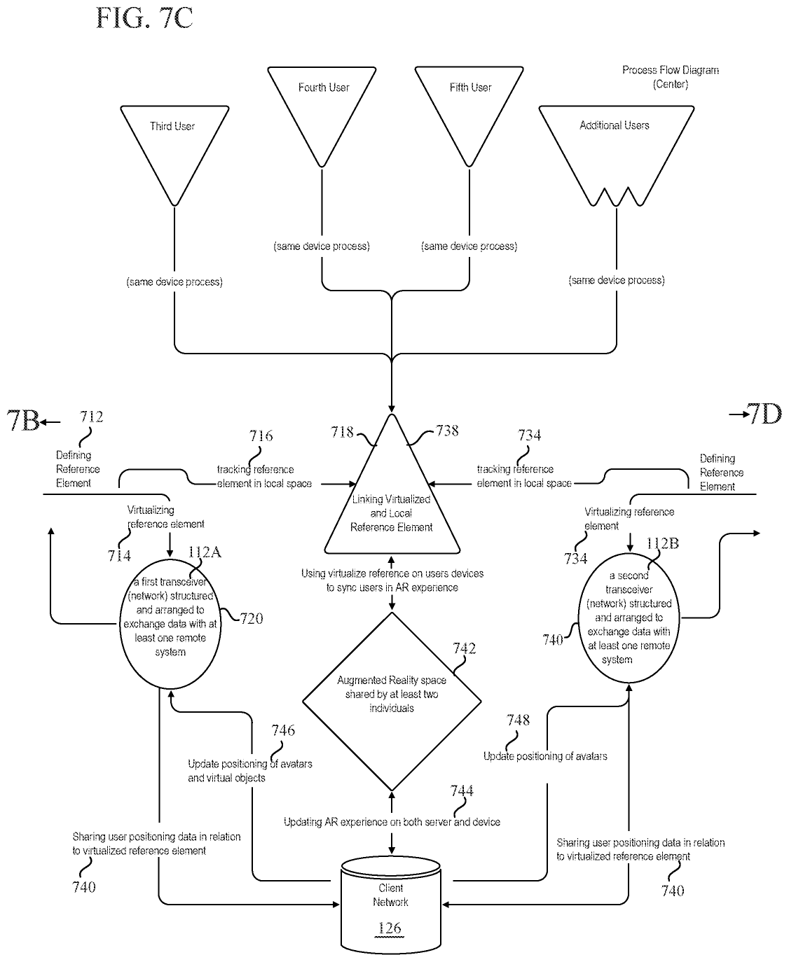

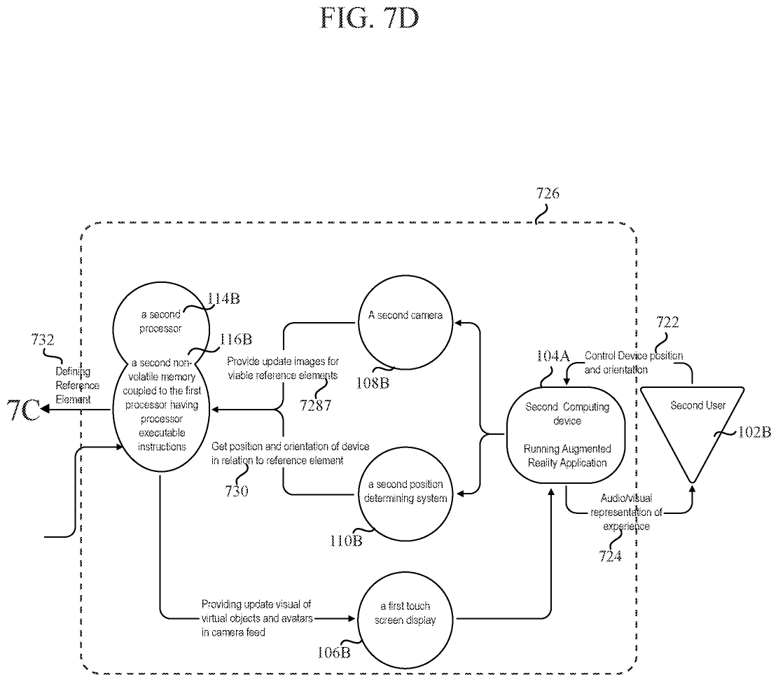

With respect to FIG. 2, as well as FIGS. 7, it will be appreciated that each User 102 is actually holding their PCD 104 in his or her hands—the PCD 104 is not disposed in a brace or holder that in turn disposed upon or otherwise attached to the user's head such that it is positioned in close proximity to his or her eyes and will remain so as he or she moves his or her head with his or her hands remaining free to grasp or engage with other objects.

To the contrary, for at least one embodiment the PCD 104 is indeed a hand held PCD 104 such that its movement is understood and appreciated to be different and independent from the movement of the user's head. That said, it will also be understood and appreciated that with respect to the augmented reality experience and virilization of the user's local space, the user's location is and should be understood to be that of their PCD 104, even though the user's eyes may be oriented in a direction that is different from that of the camera 108 of the PCD 104.

As each User 102 moves his or her PCD 104 about, ARA 122 uses the camera of the PCD 104 to provide updated images of the local space 200 around the User 102 and the position determining system of the PCD 104 provides the position and orientation information of the PCD 104. This data is then utilized by the ARA 122 to identify tracking elements in the local space 200 using an existing augmented reality heuristic plane and object identifier, for example Apple ARKit API on iOS devices and Google ARCore API on Android devices. The ARA 122 then determines the device's relationship in space to those tracked elements—at least one of which is used as a Reference Element. In varying embodiment, the Reference Element(s) may be, but are not specifically limited to: a wall, floor, ceiling, corner as between walls and ceiling or floor, planes, predefined markers, recognizable objects, stationary image, or other objects that are detected within the image of the Users local space.

Moreover, in operation, ARA 122A is provided with a video image of the first User's 102A physical local space—or at least that portion within the field of view to the camera 108A—this is the User's local space 200A. From this initial image, ARA 122A establishes a first virtualized local space 200A′ and a first user local Reference Element 202A. ARA 122A also utilizes the position determining system 110A of PCD 104A to determine the initial position data of PCD 104A relative to the first user local Reference Element 202A in the first virtualized local space 200A′. This data may be summarized local Reference Element, Location and Orientation data—aka “RELO” 204, which for the first User 102A is RELO 204A. ARA 122A directs PCD 104A to transmit the RELO 204A of the first User 102A to the remote computer system 124 for sharing and use by the client network 126.

Similarly, ARA 122B is provided with a video image of the second User's 102B physical local space—or at least that portion within the field of view to the camera 108B. From this initial image, ARA 122B establishes a second virtualized local space and a second user local Reference Element 202B. ARA 122B also utilizes the position determining system 110B of PCD 104B to determine initial position data of the PCD 104B relative to the second user local Reference Element 202B in the second virtualized local space, e.g., RELO 204B. ARA 122B directs PCD 104B to transmit the RELO 204B of the second User 102B to the remote computer system 124 for sharing and use by the client network 126.

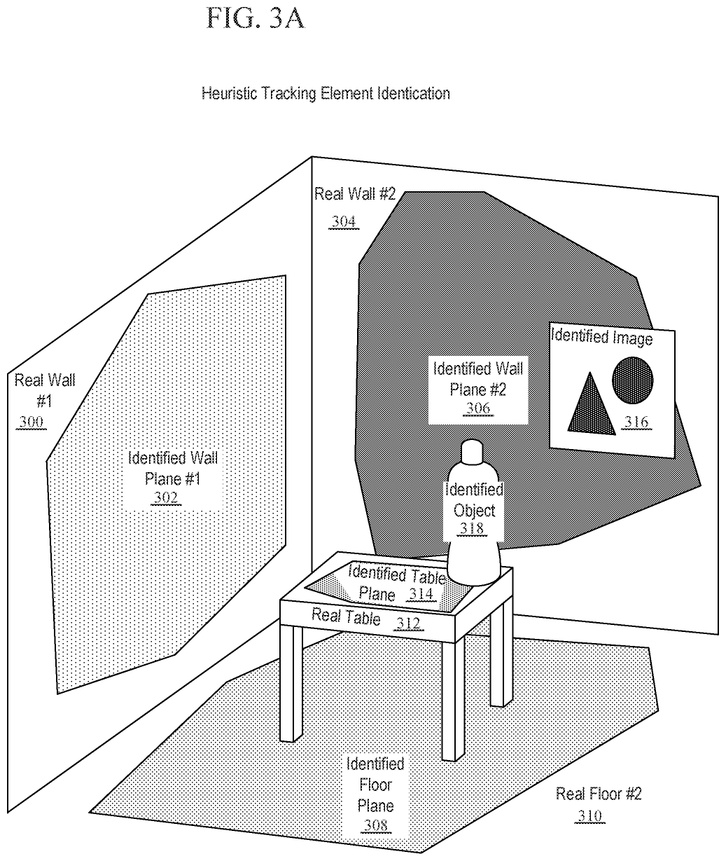

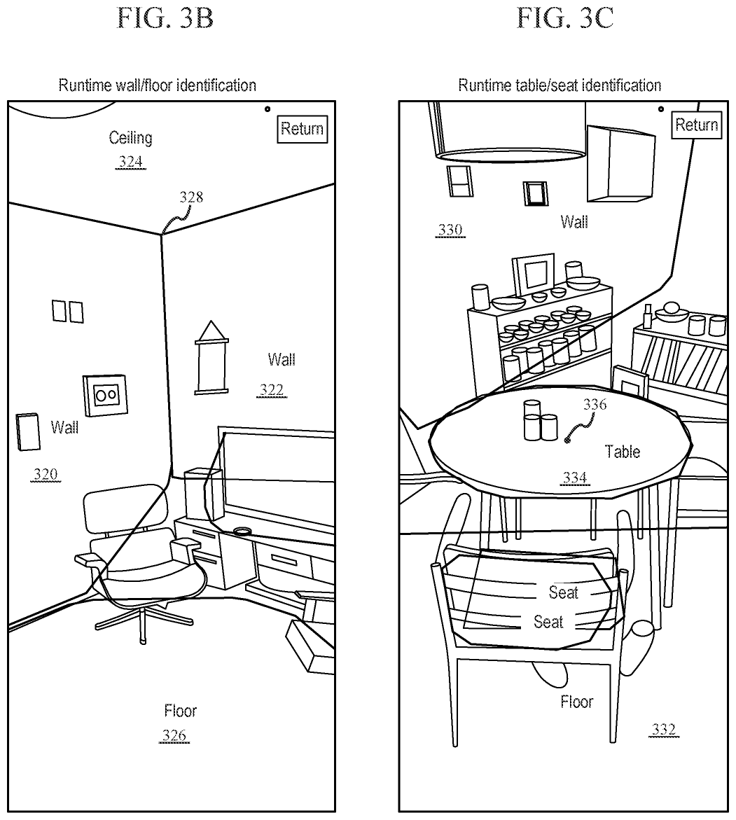

The heuristic tracking and element identification that is used for the determination of a local Reference Element 202 is more fully presented in FIG. 3A. As noted, for at least one embodiment, the ARA 122 utilized APIs. The APIs analyses the constantly updated image from the PCD 104 camera. From this image a machine learning model determines planes and objects. For example, if a plane is detected and the API uses the device accelerometer to determine that the plane is vertical and it detects that it is continuous and over a certain size, it will determine with a threshold of certainty that it is a wall. In FIG. 3, first real wall 300 has been identified as first plane 302 and second real wall 304 has been identified as second plane 306.

If a plane is detected that is horizontal and is determined to be constantly below the device and over a certain size it will determine with a threshold of certainty that it is a floor. In FIG. 3A, floor 308 is identified as third plane 310. If it is a horizontal plane above a floor with limited size is detected, ARA 122 may determine with threshold of certainty that the object is a table 312, identified by fourth plane 314.

For at least one embodiment, detection is not limited to planes. The augmented reality APIs can also identify known elements from databases as may be provided, or at least accessed, by the remote computer system 124, and which provides libraries of images or 3D reference models for comparison to elements within a captured image. Moreover, an image can be detected from an image library referenced by the API. The image could take many real-world forms, one example is a poster 316 on a wall. Similarly, a real-world object that has a 3D reference model can be detected as a known object too. For instance, a branded bottle 318. A 3D model to scale may be uploaded to a database of models and the API could reference that to determine that the real bottle has the same dimensions. It can then be used as a tracking element.

When tracking elements have been identified by ARA 122, they are continuously tracked and updated. ARA 122 may use any one of, or a combination of commonly recognized tracking elements as a single Reference Element, which for each user is known as the user local Reference Element 202. This identified user local Reference Element 202 is virtualized. For example, the top plane, aka fourth plane 314 of the table 312 is identified as the local Reference Element 202 for one User 102 and an identified branded bottle 318 is identified as the local Reference Element 202 for another User 102.

FIGS. 3B and 3C are line drawing renderings of images of actual local spaces 200 that have been analyzed by an instance of ARA 122 for the detection and identification of planes, as might be presented upon the touch display 106 of each User's PCD 104, such as in a diagnostic or testing mode of ARA 122. In FIG. 3B, the instance of ARA 122 has identified at least a first wall 320, a second wall 322, a ceiling 324 and a floor 326. From these planes, ARA 122 can establish the corner 328 between the first wall 320, the second wall 322 and ceiling 324 as a local user Reference Element.

In FIG. 3C, the instance of ARA 122 has identified at least a first wall 330, a floor 332, and a table 334. In this instance, the ARA 122 may establish the center 336 of the table 334 as a local user Reference Element.

As Users 102 are generally each in their own unique real space, the local Reference Element 202 for one User 102 may be different from that of another User 102 (different tables, or a table for one and a bottle for another, etc.). However, if Users 102 are indeed in the same real space, their respective instances of ARA 122 on their respective PCD 104 may utilize the same physical element as the local Reference Element 202 for each Users 102 virtualized local space.

With respect to FIG. 3, a PCD 104 running an instance of ARA 122 can identify first real wall 300 as first plane 302, second real wall 304 as second plane 306 and floor 308 as third plane 310. The ARA 122 may further determine via the proximity of their edges and their orientation in relation to each other that in reality these three planes likely intersect. The ARA 122 may then use that intersection to create a virtual corner Reference Element, as a local Reference Element 202.

The remote computer system 124 receives the digital data transmissions of RELO 204A from the first User 102A and the RELO 204B from the second User 102B. Simply stated, the remote computer system 124 defines an initial origin for the virtualized reality space—e.g., the center point of the virtualized reality space—this is the initial Virtualized Reference Element 206. The remote computer system 124 then maps the first user local Reference Element 202A to the Virtualized Reference Element 206 and the second user local Reference Element 202B to the Virtualized Reference Element 206. For at least one embodiment, this mapping is achieved by determining a center point of the first user local Reference Element 202A and a center point of the second user local Reference Element 202B.

For at least one embodiment, each User's Virtualized Reference Element is precisely aligned with the origin Reference Element, such that all Users have essentially the same general orientation with respect to origin Reference Element, and therefore each other's Virtualized Reference Element, the precise virtual location of each user determined by the RELO 204 data determined by their respective PCD 104. As such it is entirely possible that two or more Users could be appearing to occupy the same, or part of the same, virtual space, however as the space is augmented reality space is indeed virtual, co-occupation is essentially a non-event.

For at least one alternative embodiment, so that the Users 102 are not initially disposed next to each other in the virtualized reality space, the remote computer system 124 may employ a random value generator to randomly select the number of degrees the second User 102B is from the first User 102A, from about 0 to 90 degrees within the horizontal plane common to the collocated first user local Reference Element 202A, the second user local Reference Element 202B and Virtualized Reference Element 206.

The location of the first User 102A is provided to PCD 104B of the second User 102B such that ARA 122B can generate an avatar 208 of each User 102, e.g., avatar 208A for User 102A and avatar 208B for user 102B.

Moreover, it is the PCD 104 of each User 102 that determines the PCD 104 position and orientation with respect to the user local Reference Element 202. The SAS 100 then orients an Augmented Reality experience for the user by mapping the user local Reference Element 202 to the origin (center) of the virtual reality space. With the user local Reference Element 202 and the Virtualized Reference Element 206 aligned, the User 102 position and orientation data (RELO 204) is then utilized to determine where the User 102 is within the virtualized augmented reality. As all PCDs 104 are sharing their position and orientation data with the remote computer system 124, their respective relationships to one another with respect to the Virtualized Reference Element is also shared with each PCD 104.

For at least one embodiment, SAS 100 further permits Users 102 to add virtual objects into his or her virtualized local space by tapping on the display 106 of his or her PCD 104. Upon such a tap, the ARA 122 may display a drop-down menu of possible objects, such as, for example a confetti cannon, basketball hoop, target, fountain, presentation screen, or other object of desire. The User 102 may be permitted to move and scale the object within the virtualized local space, and when released, the ARA 122 will generate position and orientation data for the new object relative to the local Reference Element, which in turn is shared with the remote computer system 124, and subsequently the client network 126.

Indeed, it will be understood and appreciated that each user does not see a representation of himself or herself within the virtualized space. However, virtualized objects that are created and added may be seen and even interacted with by other users as, absent a user setting to limit view and access, these virtual objects are understood and appreciated to be added to the global experience state of SAS 100 such that they may be perceived by all Users 102 sharing an augmented reality experience.

In other words, the PCD 104A of the first User 102A receives data from the remote computer system 124 of a rectified augmented reality experience 210A with avatars 208 and objects positioned with respect to the mapped first user local Reference Element 202A and the PCD 104B of the second User 102B receives data from the remote computer system 124 of a rectified augmented reality experience 210B with avatars 208 and objects positioned with respect to the mapped second user local Reference Element 202B. Each PCD 104 uses the rectified augmented reality experience 210 data to generate at least visual elements (avatars 208 and/or objects) which are superimposed upon the display 106 for visual perception by the User 102, when and as these avatars 208 and/or objects are in the virtualized local space as perceived by the camera 108 of the PCD 104.

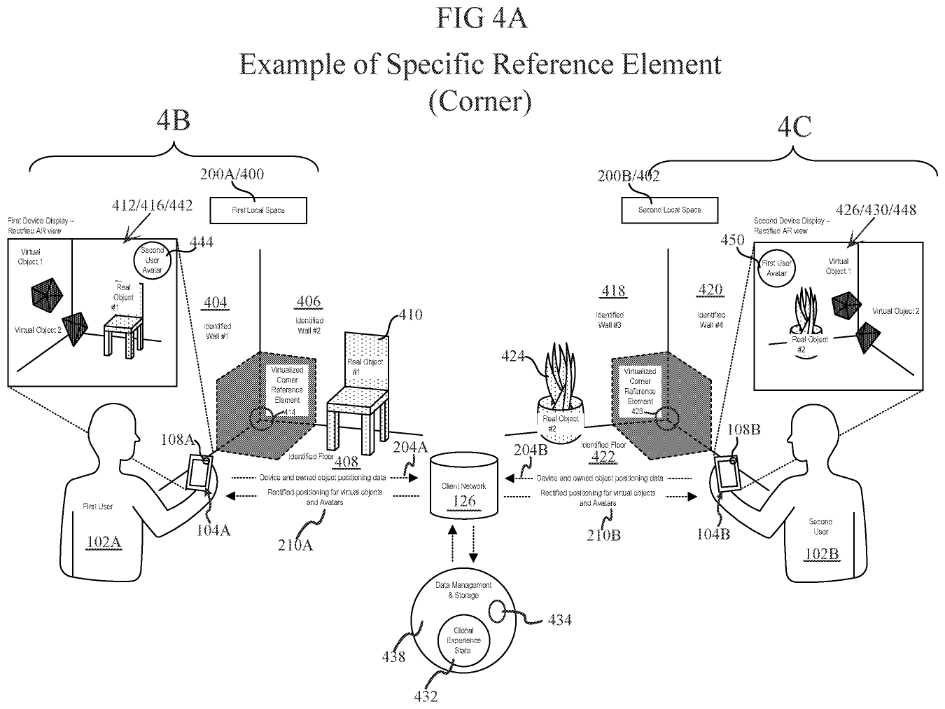

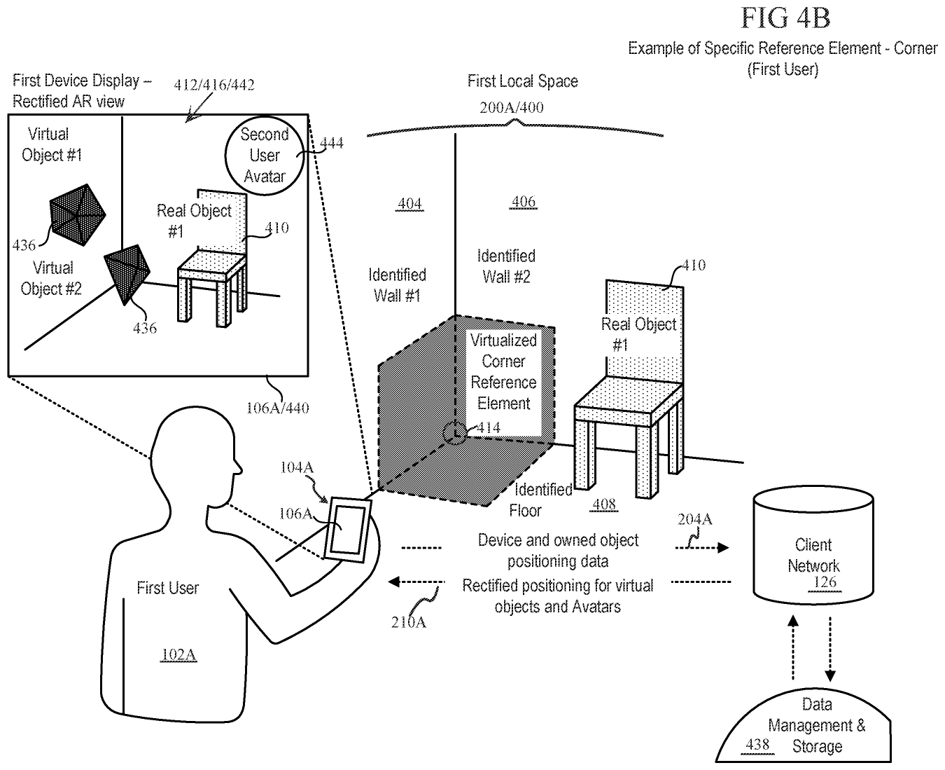

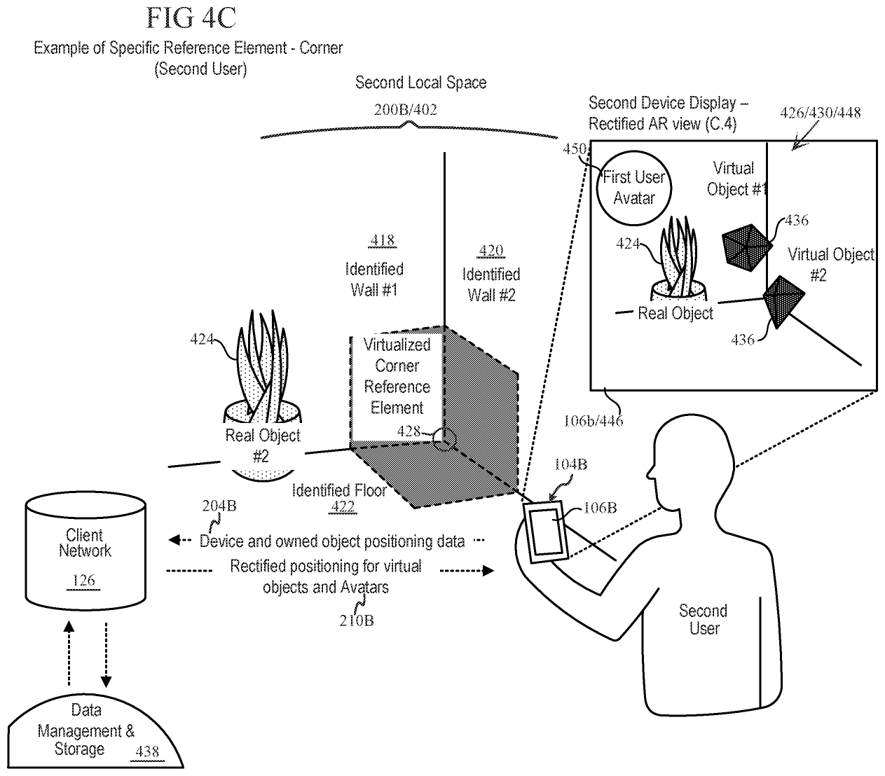

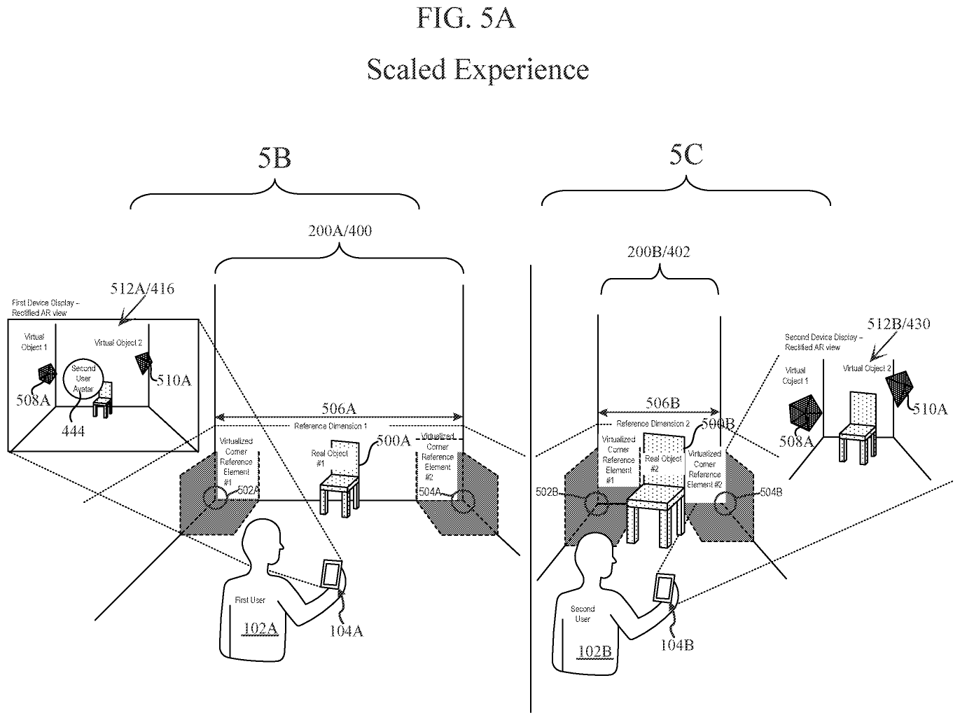

With respect to the overview provided by FIGS. 1, 2 and 3, FIGS. 4A, 4B and 4C present a more detailed conceptualization of an embodiment of SAS 100 as used by two Users and the determination of a user local Reference Element within each physical and virtualized Users local space. More specifically, FIG. 4A provides an entire view of both User local spaces, with FIG. 4A providing an enlarged view of the first User's 102A local space and FIG. 4B providing an enlarged view of the second User's 102B local space.

As may be appreciated in FIGS. 4A-4C, the first User 102A has a first PCD 104A having a first display 106A and a first camera 108A and the second User has a second PCD 104B having a second display 106B and a second camera 108B. Each User 102 uses his or her PCD 104 to capture an image of his or her local space—first local space 400 for first User 102A and second local space 402 for second User 102B.

As may be more fully appreciated in FIG. 4B, the first local space 400 includes a first wall 404, second wall 406 and floor 408. There is also shown a real physical object, a chair 410. As discussed above with respect to FIG. 3, first User 102A is directing his PCD 104A towards these elements in the first local space 400 such that the camera 108A captures a first image 412 of the first local space 400. The ARA 122A on PCD 104A using AIPs and the processor of the PCD 104A is able to determine a first plane for the first wall 404, a second plane for the second wall 406 and a third plane for the floor 408, and from the location and arrangement of these three planes, determine a corner 414 as the first user local Reference Element 202A. First image 412 with the first user local Reference Element 202A may be appreciated as the first virtualized local space 416.

As also noted above, the ARA 122A is also structured and arranged to utilize the position determining system of PCD 104A to determine the location and orientation of the first PCD 104A. The Reference Element, and location and orientation data, aka RELO 204A data is wirelessly transmitted by the first PCD 104A to the client network 126, and more specifically the remote computer system 124 at least in part supporting the client network 126. This RELO 204A data may also include additional position data for owned/real objects within the first local space 400, such as the location of chair 410 relative to the first user local Reference Element 202A.

Similarly, as may be more fully appreciated in FIG. 4C, the second local space 402 includes a third wall 418, fourth wall 420 and second floor 422. There is also shown a real physical object, a plant 424. As discussed above with respect to FIG. 3, second User 102B is directing his PCD 104B towards these elements in the second local space 402 such that the camera 108B captures a second image 426 of the second local space 402. The ARA 122B on PCD 104B using AIPs and the processor of the PCD 104B is able to determine a first plane for the third wall 418, a second plane for the fourth wall 420 and a third plane for the second floor 422, and from the location and arrangement of these three planes, determine a corner 428 as the second user local Reference Element 202B. Second image 426 with the second user local Reference Element 202B may be appreciated as the second virtualized local space 430

As also noted above, the ARA 122B is also structured and arranged to utilize the position determining system of PCD 104B to determine the location and orientation of the first PCD 104B. The Reference Element, and location and orientation data, aka RELO 204B data is wirelessly transmitted by the second PCD 104B to the client network 126, and more specifically the remote computer system 124 at least in part supporting the client network 126. This RELO 204B data may also include additional position data for owned/real objects within the second local space 402, such as the location of plant 424 relative to the second user local Reference Element 202B.

The remote computer system 124 receives the digital information provided as RELO 204A for the first User 102A and RELO 204B for the second User 102B. The remote computer system 124 maps the first user local Reference Element 202A to the Virtualized Reference Element 206 (discussed with respect to FIG. 2) and maps the second user local Reference Element 202B to the Virtualized Reference Element 206. In so doing, the remote computer system 124 generates the rectified augmented reality experience 210, as the first virtualized local space 416 and the second virtualized local space 430 are related to each other by their respective local Reference Element 202 for the first User 102A and 428 for the Second User.

Moreover, the remote computer system 124 maintains a global experience state 432 of the rectified augmented reality experience 210. Simply described the global experience state 332 is a record of at least the location of each User 102 (more specifically their PCD 104) with respect to their Reference Element which has been mapped to the Virtualized Reference Element 206.

The remote computer system 124 may further augment the rectified augmented reality experience 210 by adding avatars 434 of the first User 102A and the second User 102B. For at least one embedment, the avatars 434 of each remote user 102 are displayed upon a User's PCD 104 display 106 in a static location—e.g. upper right, lower right, upper left, lower left, etc. . . . For at least one embodiment, a User 102 may use the touch screen properties of display 106 to move an avatar to a desired location upon the display.

Users 102 may also opt to create a virtual object 436 that is added to the virtualized local space. For at least one embodiment, the remote computer system 124 has at least one database 438 for data management and storage. A User 102 may tap the display 106 of the PCD 104 and select a menu option for a virtual object 436, the placement of the virtual object 436 being indicated by the user tapping their finger upon the display 106.

The ARA 122, and more specifically the API's, determines the location of the virtual object 436 which is in turn communicated as wireless digital data to the remote computer system 126 where this selected virtual object 436, the User 102 who instantiated it, and the virtual object's relative position are recorded in the database 438 and thus made available for the global experience state 432. When a User 102 manipulates a virtual object 436, such manipulation is reported by the user's ARA 122 back to the remote computer system 124 which in turn updates the database 138. In this way, changes to virtual objects 436 are disseminated to all connected Users 102.

More specifically, in FIG. 4B, the enlargement 440 of the display 106A shows that PCD 104A is displaying a rectified augmented reality view 442 of the first User's first local space 400 with an avatar 444 of the second User 102B and virtualized object(s) 436. Similarly, in FIG. 4C, the enlargement 446 of the display 106B shows that PCD 104B is displaying a rectified augmented reality view 448 of the second User's second local space 402 with an avatar 450 of the first User 102A and virtualized object(s) 436.

As the first User 102A moves about, the RELO 204A data is continuously updated and transmitted as digital data to the remote computer system 124 which in turn generates updated rectified augmented reality experience 210 data which is wirelessly communicated as digital data back to each user's PCD 104. The same is true with respect to the second User 102b moving about in his or her second local space 402.

To facilitate such synchronization between Virtual Objects 436, in addition to determining each user's local reference element 202 for each local space, the ARA 122 can also adapt each PCD 104 to determine a reference dimension for the virtualized local space 200′. It will be appreciated that unless the users 102 are in the same physical location, or in rooms or spaces of identical dimensions, there will be differences in the physical dimensions of each user's real-world local space—one user 102 may be in a living room, while another user 102 may be in a dining room, ball room, auditorium, or other space.

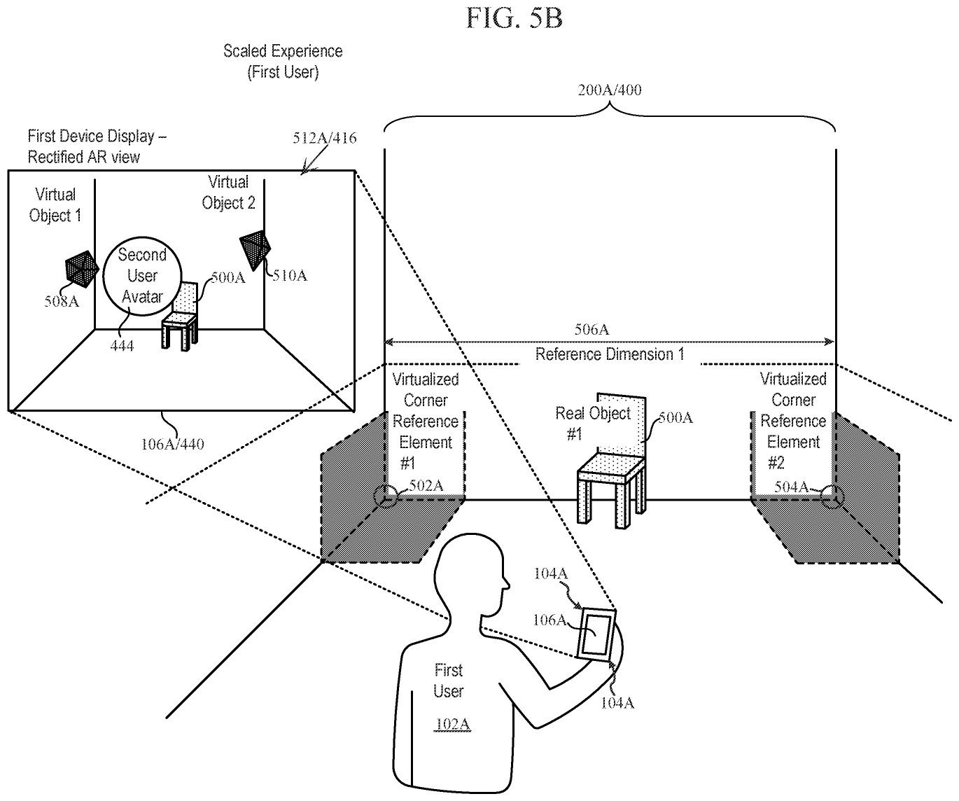

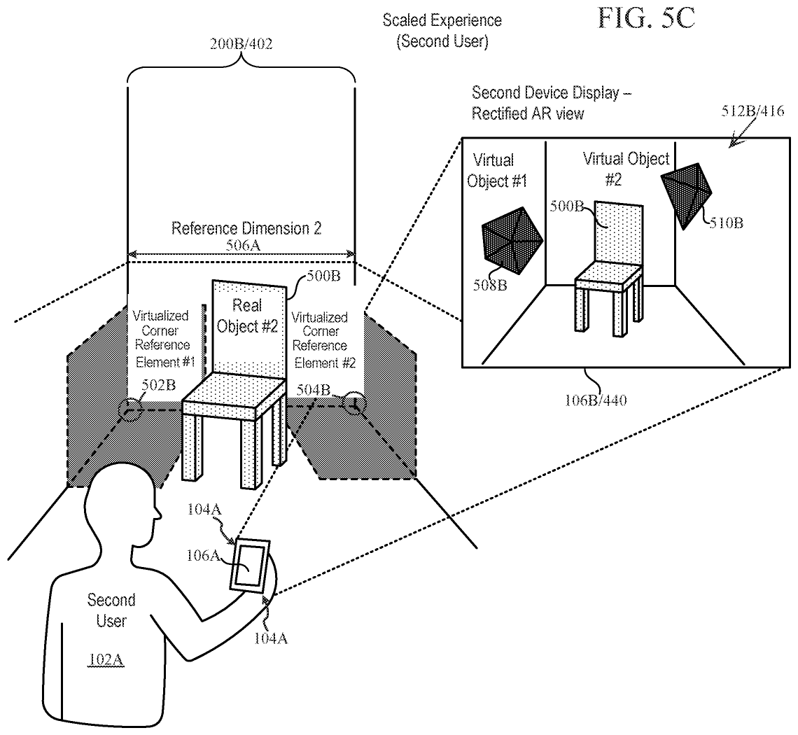

Similar to FIGS. 4A-4C, FIGS. 5A-5C provide a conceptualization of the advantageous ability of SAS 100 to incorporate reference dimension with respect to the virtualized local space 200′. More specifically, FIG. 5A provides an entire view of both User local spaces, with FIG. 5A providing an enlarged view of the first User 102A local space, more specifically the first User 102A local space 200A, and FIG. 5B providing an enlarged view of the second User 102B local space, more specifically the second User 102B local space 200B.

As may be appreciated in FIG. 5B, the first user 102A local space 200A is very different in size from the second user 102B local space 200B. More specifically, local space 200A is considerably larger than local space 200B. Local space 200A may be identified as the first local space 200A and local space 200B may be identified as the second local space 200B.

A real-world object—specifically a chair 500 is shown in both the first user 102A local space 200A and the second user 102B local space 200B, and it will be understood and appreciated that chair 500A is essentially the same as chair 500B.

More specifically, FIG. 4A provides an entire view of both User local spaces (400 and 402), with FIG. 4A providing an enlarged view of the first User's 102A local space and FIG. 4B providing an enlarged view of the second User's 102B local space.

The first User's PCD 104A running ARA 122A has identified and virtualized two corner reference elements 502A and 504A using the process as set forth above with respect to FIGS. 3-4C. The second User 102B in the second local space has done the same, their ARA 122B having identified and virtualized two corner reference elements 502B and 504B. By virtue of having two references for a given local space, ARA 122 on each PCD 104 can now scale the augmented reality experience to rectify between the two spaces.

Moreover, for the first User 102A, ARA 122A determines a first reference dimension 506A and for the second user 102B, ARA 122B determines a second reference dimension 506B. These respective reference dimensions can now be used to set the positioning of virtual objects 436 as well as avatars 434 relatively while maintaining their “real world” scale in each experience.

As is shown in FIGS. 5A-5B, first virtual object 508 and second virtual object 510 both appear in relative positions to the reference dimension of each augmented reality space, i.e., rectified augmented reality view 512A for the first User 102A and rectified augmented reality view 512B for the second User 102, while maintaining a consistent scale as observable in relation to a real object such as chair 500. More specifically first virtual object 508A and second virtual object 508A as presented in rectified augmented reality view 512A are smaller and farther apart whereas first virtual object 508B and second virtual object 508B as presented in rectified augmented reality view 512B are larger and closer together.

Further, in the exemplary illustration of FIGS. 5A-5C, the first User 102A perceives the avatar 444 of the second User 102B because the second User 102B is further forward in the virtualized space—in other words, the second User 102B appears to be standing in front of the first User 102A.

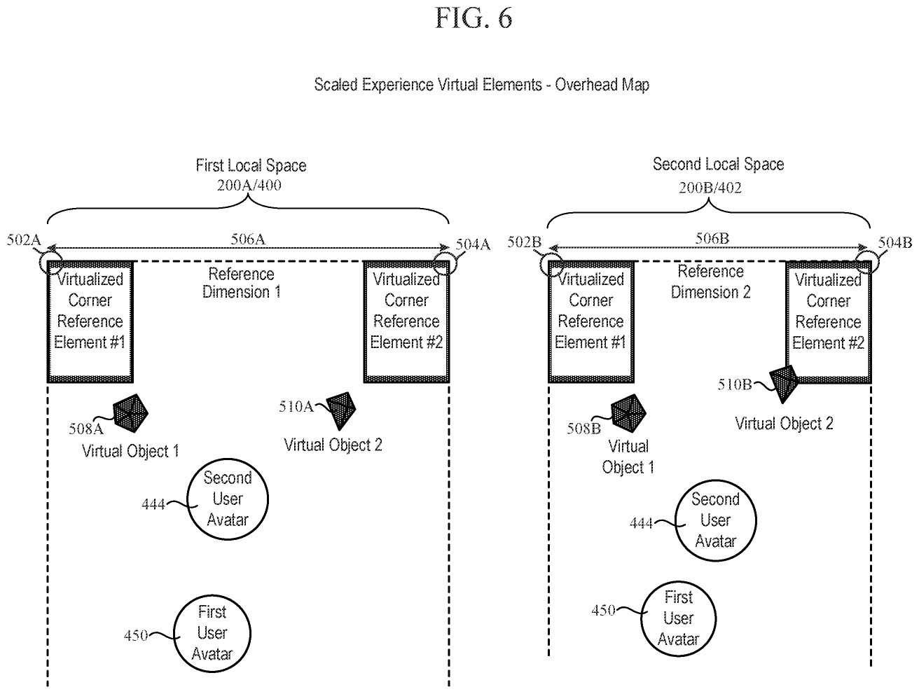

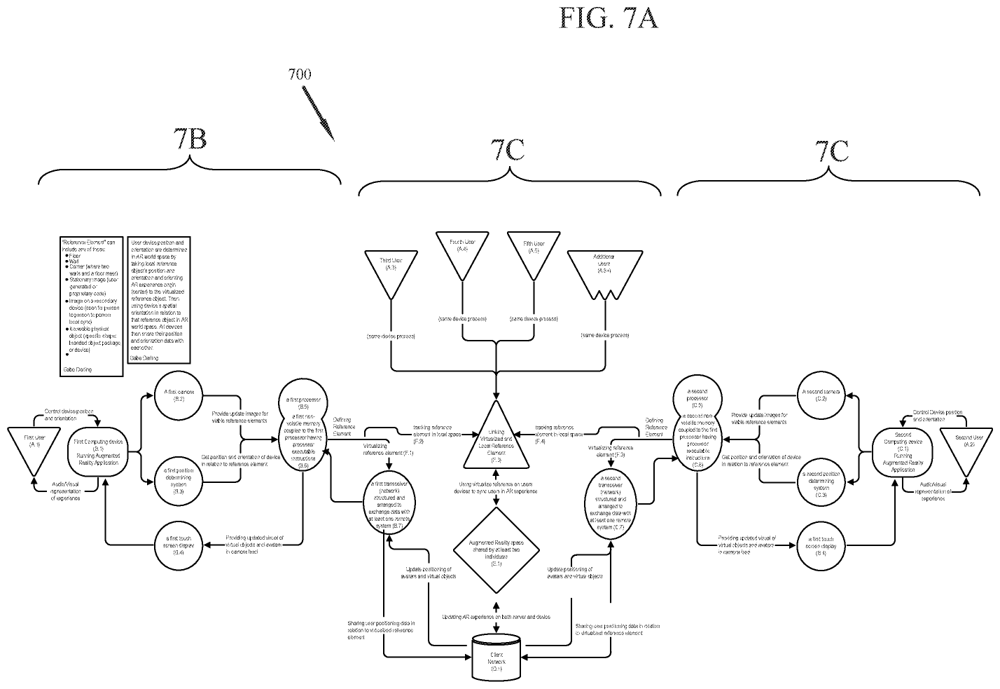

To further appreciate this issue of scaling with a reference dimension, FIG. 6 presents a conceptualization of a top-down view of the local space 200A and second local space 200B as shown in FIGS. 5A-5C. As will be appreciated, objects retain their individual scales across virtualized experiences but the scale of each experience is adjusted according to its reference dimension 506 as determined by corner reference elements 502 and 504—reference dimension 506A as determined by corner reference elements 502A and 504A in the first local space 200A, and reference dimension 506B as determined by corner reference elements 502B and 504B in the first local space 200A.

With respect to the above detailed narration and discussion of the figures, embodiments of SAS 100 may be summarized as a system and method that permits two or more PCDs 102 to synchronize and share augmented reality experiences both locally and remotely.

For at least one embodiment, SAS 100 includes a remote computer system 124 having a processor and a database 438. The database 438 will be appreciated to have a user account for each User 102 utilizing an instance of an application for augmented reality, with each user account including at least each user's last known location and orientation with respect to a reference element 202 as defining a virtualized local space 200′ for each User 102 as virtualized user data. For a new user account just being established, it will be understood and appreciated that his or her last known location and orientation may be indicated as null values, or a default such as 0,0,0-0, or the like.

The system further includes an Augmented Reality Application (ARA 122) for installation upon a user's PCD 104 to be hand held by the user 102 during an augmented reality session, the ARA 122 having at least: a virtualized local space generator 128 structured and arranged to generate from an image of the user's local space the virtualized local space and the reference element 202 within the image of the user's local space and the virtualized local space; a virtual object generator 130 structured and arranged to generate at least one virtualized object within the virtualized local space 200′ with respect to the virtualized reference element 202; a mapper 132 structured and arranged to map the reference element 202 from a local instance of the ARA 122 to the an origin of the virtual reality space maintained by the remote computer system 124 as the initial Virtualized Reference Element 206. As each local reference element is mapped to the Virtualized Reference Element, each virtualized local space 200′ is thereby aligned.

A local User 102 desiring an augmented reality experience provides a PCD 104 having at least a processor 112 with non-volatile memory 116, a camera 108, a touch display 106, a position determining system 110, and a transceiver 112, and an instance of the ARA 122.

For each PCD 104, the ARA 122 ARA adapts the processor 114 to use the camera 108 to obtain an image of the user's local space 200. From this image, the ARA 122 develops a virtualized local space 200′ having at least one virtual local Reference Element associated with a local Reference Element in the user's local space 200. The ARA 122 also obtains position and orientation of the PCD 104. Collectively, at least the virtual local Reference Element and location and orientation data (RELO 204) is shared as digital data with the remote computer system 124 and other PCDs 104 representing other Users 102.

Moreover, as Augmented Reality is understood and appreciated to be an interactive experience that combines the real world and computer-generated content, it will be understood and appreciated that as ARA 122 adapts a User's existing PCD 104 to participate in an interactive experience, SAS 100 advantageously permits a tremendous range of possibilities and experience, such as educational, recreational, therapeutic and others. As the video images are adapted and rectified in real time for the integration of virtual objects it will be understood and appreciated that SAS 100 is dependent upon computer processing for the real time evaluation, mapping and alignment of virtual objects for rendering upon the display 106.

For at least one embodiment, the methodology of SAS 100 may be summarized as obtaining on a first PCD 104A held out by a first user 102A a first image 412 of the first user's local space 202A; generating a first virtualized local space 200A′ based on the first image 412 and defining a first reference element 202A; determining the first user's location and orientation relative to the first reference element 202; sharing at least the first reference element 202A and the first user's location and orientation as virtualized first user data with at least one remote computer system 124 having a processor and a database 438; obtaining on a second PCD 104B held out by a second user 102B a second image 426 of the second user's local space 200B; generating a second virtualized local space 200B′ based on the second image 426 and defining a second reference element 202B; determinizing the second user's location and orientation relative to the second reference element 202B; sharing at least the second reference element 202B and the second user's location and orientation as virtualized second user data with the at least one remote server system 124; receiving upon the second PCD 104B from the at least one remote server system 124 the virtualized first user data, the second PCD 104B mapping the second reference element 202B to the first reference element 202A to align the second virtualized local space 200B′ to at least a portion of the first virtualized local space 200A′ with a first avatar of the first User 102A presented based on the first user's location and orientation; receiving upon the first PCD 104B from the at least one remote server system the virtualized second user data, the PCD 104B mapping the first reference element 202A to the second reference element 202B to align the first virtualized local space 200A′ to at least a portion of the second virtualized local space 200B′ with a second avatar of the second user presented based on the second user's location and orientation; wherein the first PCD 104A and the second PCD 104B exchange first user location and orientation and second user location and orientation information to continuously revise presentations of the first virtualized local space and the second virtualized local space as an augmented reality space and the first avatar and the second avatar relative to the first reference element.

In light of the above description, at least one embedment of SAS 100 may be more fully appreciated with respect to FIGS. 7A, 7B, 7C and 7D—FIG. 7A presenting a process flow diagram 700 outlining the exchange of data between PCD 104 and a central network to facilitate the synchronizing of augmented reality space and experience. FIGS. 7B, 7C and 7D provide enlarged views of the left, center and right sections of the process flow diagram for ease of review.

As may be most easily appreciated in FIG. 7B, the first User 102A has operational control over a PCD 104A running an instance of ARA 122A. The first User 102A can control the device position and orientation, action 702, and the PCD 104A provides the first User 102A with an audiovisual representation of the augmented reality experience, action 704.

This is achieved at least in part as PCD 104A has a first camera 108A, a first position determining system 110A, and a first touch screen display 106A, and a first transceiver 112A, each of which is coupled to and at least partially controlled by a first processor 114A, the association of these elements as part of PCD 104A shown by dotted line 706.

The first camera 108A provides continuously updated images of the first user's local space to the first processor 114A, each image providing viable reference elements, action 708. The first position determining system 110A provides location and orientation of the PCD 104A to the first processor 114A, action 710.

Utilizing one or more API's as provided by the ARA 122A, the first processor 114A is able to determine at least one Reference Element in the images provided, action 712, and virtualize it as a data so as to generate digital data identifying the location of the virtualized Reference Element and the location and orientation of the PCD 104A with respect to the virtualized Reference Element, action 714.

As the first User 102A moves his or her PCD 104A, the image of the local space captured by the camera 108A will of course change. In other words, the physical location of the actual Reference Element in the image will change, but so too will the virtualized Reference Element as they are correlated to each other.

This tracking of the physical reference element to update the location of the virtualized Reference Element, action 716, permits SAS 100 to firmly link the local/physical Reference Element with the virtualized Reference Element for first user's virtualized local space, event 718.

Digital data representing at least the first user's virtualized Reference Element and the location and orientation of the PCD 104A is wirelessly shared by the first transceiver 112A with at least one remote computing system, action 720.

Essentially paralleling the actions of the first User 102A, as shown in FIG. 7D, a second User 102B has operational control over a PCD 104B running an instance of ARA 122B. The second User 102B can control the device position and orientation, action 722, and the PCD 104B provides the second User 102B with an audiovisual representation of the augmented reality experience, action 724.

This is achieved at least in part as PCD 104B has a second camera 108B, a second position determining system 110B, and a second touch screen display 106B, and a second transceiver 112B, each of which is coupled to and at least partially controlled by a second processor 114B, the association of these elements as part of PCD 104B shown by dotted line 726.

The second camera 108B provides continuously updated images of the second user's local space to the second processor 114B, each image providing viable reference elements, action 728. The Second position determining system 110B provides location and orientation of the PCD 104B to the second processor 114A, action 730.

Utilizing one or more API's as provided by the ARA 122B, the second processor 114B is able to determine at least one Reference Element in the images provided, action 732, and virtualize it as a data so as to generate digital data identifying the location of the virtualized Reference Element and the location and orientation of the PCD 104B with respect to the virtualized Reference Element, action 734.

As the second User 102B moves his or her PCD 104B, the image of the local space captured by the camera 108B will of course change. In other words, the physical location of the actual Reference Element in the image will change, but so too will the virtualized Reference Element as they are correlated to each other.

This tracking of the physical reference element to update the location of the virtualized Reference Element, action 736, permits SAS 100 to firmly link the local/physical Reference Element with the virtualized Reference Element for second user's virtualized local space, event 738.

Digital data representing at least the second user's virtualized Reference Element and the location and orientation of the PCD 104B is wirelessly shared by the first transceiver 112B with at least one remote computing system, action 740.

As shown in FIG. 7C, the first transceiver 112A and the second transceiver 112B are in wireless communication with the client network 126 of the SAS 100 as provided at least in part by the remote computer system 124. As discussed above, the remote computer system 124 provides a database 438 which provides data management and storage for the digital data representing each User's virtualized local space—specifically at least each user's Virtualized Reference Element and the position and location of their PCD 104 relative to the Virtualized Reference Element. Collectively, this data represents the global experience state as it is the augmented reality space shared by at least two Users 102, state 742.

As state 742 is updated and revised due to movement of each PCD 104 and the subsequent re-generation of each user's virtualized local space, the location of their virtualized Reference Element and the location of their PCD 104, remote computer system 124 updates the map of the augmented reality, state 744, and transmits this updated data stream back to each PCD 104, action 746 and action 748.

This data, received by the first transceiver 112A and the second transceiver 112B is processed by the first processor 114A and the second processor 114B, the first processor 114A generating an updated image of the augmented reality space on the first display 106A and the second processor 114B generating an updated image of the augmented reality space on the second display 106B.

As such, the first User 102A and the second User 102B each perceives a continuously updated augmented reality space merged with that portion of their physical reality space that is visible to their respective PCDs 104A and 104B, and more specifically the cameras 108A and 108B.

Described with respect to just a first User 102A and a second User 102B, it will be understood and appreciated that SAS 100, and more specifically the process diagram 700 may accommodate a plurality of additional Users 102, such as third User 102C, fourth User 102C, fifth User 102D, and Nth User 102N.

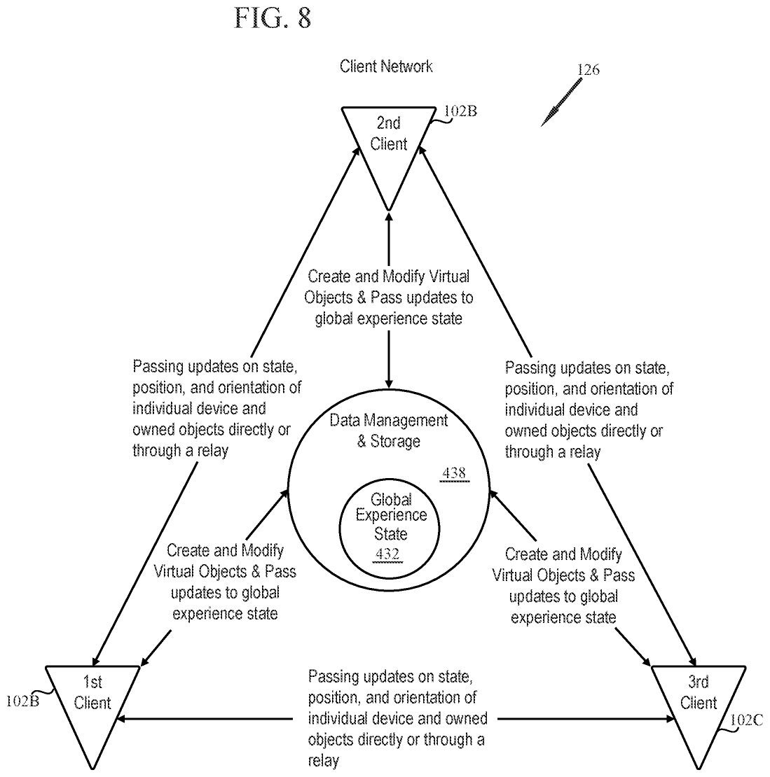

FIG. 8 presents yet another conceptualized view of an exemplary client network 126. Each individual User 102 has a PCD 104 running an instance of ARA 122. As shown, there are three exemplary Users—first User 102A, second User 102B and third User 102C, but it will be understood and appreciated that embodiments of SAS 100 are not limited to only three Users 102. With respect to the client network 126, each user's PCD 104 is appreciated to be an actual network client in terms of digital data exchange as human users are incapable of being network clients. Accordingly, User 102A is represented by PCD 104A, User 102D is represented by PCD 104B and User 102C is represented by PCD 104C.

As shown, each PCD 104 connected to a client network 126 as provided at least in part by the remote computer system 124 also providing the database 428 for data and management storage and global experience state 432.

Each PCD 104 as a client, passes digital data updates on state, position, and orientation of that individual PCD 104 and all “owned” virtual objects directly or through a server-side relay to each other PCD 104 on the network using Websockets, TCP, Reliable UDP, or other similar networking protocols. A server-side relay system holds open connections from all PCD 104 clients on the network and rapidly passes data between PCD 104 clients. One embodiment of this networking topology is “Photon Engine Realtime,” developed by Exit Games in Hamburg, Germany.

Each PCD 104 client communicates with the remote computer system 124 for access to the database 438 and the data storage and management system holding the global experience state 432—which as described above is a digital record of the current state and pertinent changes to all virtual objects, user RELO 204 data, and general experience settings that provide each rectified augmented reality view displayed by each PCD 104 to its User 102. This way, each PCD 104 client in each connected client network (also known as the Global Experience Network) gets a rectified version of the shared augmented reality experience in substantially real time.

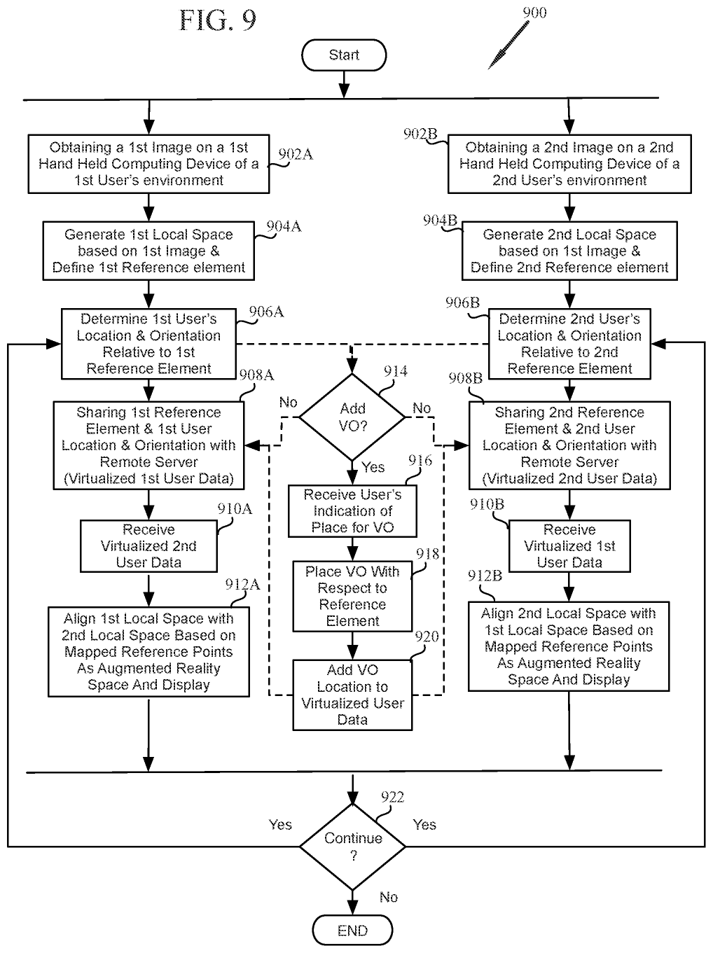

Having described embodiments for SAS 100 as shown with respect to FIGS. 1-8, other embodiments relating to at least one method for synchronizing augmented reality experiences between at least two people will now be discussed with respect to FIG. 9, in connection with FIGS. 1-8. It will be appreciated that the described method need not be performed in the order in which it is herein described, but that this description is merely exemplary of one method for synchronizing augmented reality experiences between at least two people in accordance with the present invention.

As FIGS. 1-8 have made clear, for at least one embodiment of SAS 100 each User 102 has a PCD 104 that has been adapted by an installed instance of ARA 122 for participation in the SAS 100 environment. For ease of discussion and illustration, it is presumed that each User 102 has a PCD 104 so enabled with ARA 122 before method 900 is initiated.

For the exemplary embodiment of method 900, there are two Users 102, once again a first User 102A and a second User 102B. Method 900 commences with the first User 102A obtaining a 1^{st} image on their first PCD 104A of the first User's environment, block 902A. Similarly, a second User 102B obtains a 2^{nd} image on a their second PCD 104B of the second User's environment, block 902B.

The first PCD 104A adapted by ARA 102A generates a first local space based on the first image and defines a first reference element, block 904A. Likewise, second PCD 104B adapted by ARA 104B generates a second local space based on the second image and defines a second reference element, block 904B.

The first PCD 104A then determines the first User's location and orientation relative to the first reference element, block 906A. Likewise, the second PCD 104B determines the second User's location and orientation relative to the second reference element, block 906B.

The first PCD 104A then shares the first reference element and the first User's location and orientation (RELO 204A), with the remote computer system 124, block 908A. Likewise, the second PCD 104B then shares the second reference element and the second User's location and orientation (RELO 204B), with the remote computer system 124, block 908B.

For at least one embodiment of method 900, the remote computer system 124 maps each user's local reference element to an origin Virtualized Reference Element such that the locations of each user in the augmented reality space is synchronized. In other words, the remote computer system 124 establishes the global experience state—e.g., where each User 102 is relative to the synchronized origin reference element.

This synchronized information is transmitted as digital information back to each user's PCD 104, such that the first User 102A receives the virtualized second User's location data, block 910A and the second User 102B receives the virtualized first User's location data, block 910B.

With this data, the first PCD 104A aligns the second local space with the first local space based on the mapped reference elements and presents the first User 102A with an augmented reality upon the display 106A of PCD 104A, block 912A. Likewise, the second PCD 104A aligns the first local space with the second local space based on the mapped reference elements and presents the second User 102A with an augmented reality upon the display 106B of PCD 104B, block 912B.

As is further shown by FIG. 9, each User 102 may optionally add a virtual object, decision 914. When a User 102 opts to add a virtual object he or she indicates on their touch display the location within the image that they wish to provide the virtual object. Their PCD 104 receives the indicated location from the touch display 106, block 916.

The PCD 104 as adapted by the ARA 122 then permits the User 102 to select the type of virtual object, such as from a drop-down list, and then places the virtual object within the image and determines the location of the now positioned virtual object with respect to the reference element, block 918.

The type of virtual object and location of the virtual object with respect to the reference element is then added to the user's virtualized data (RELO 204) and shared as digital data with the remote computer system 124, block 920.

The method 900 continues, decision 922, so long as the Users 102 remain active with SAS 100.

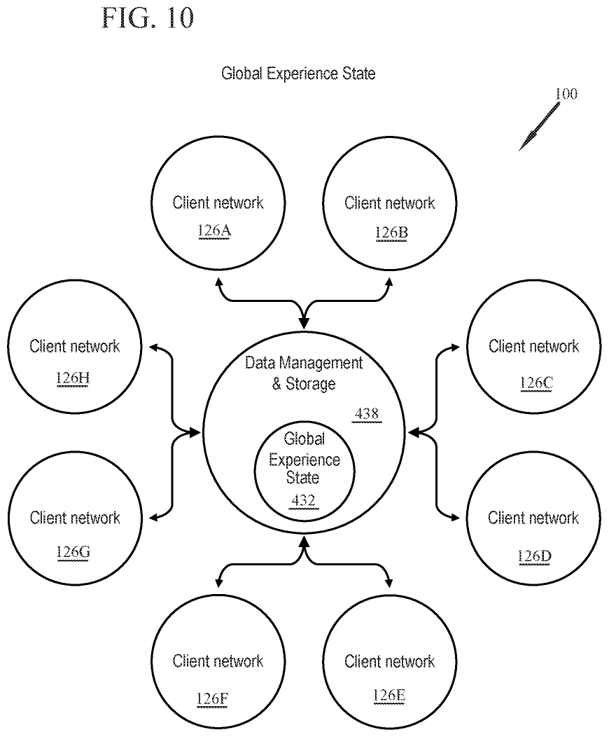

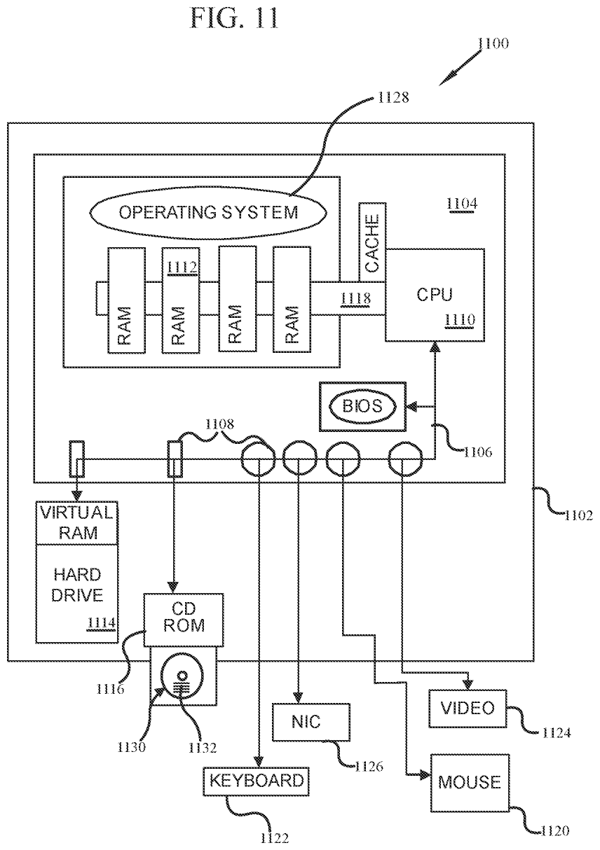

FIGS. 10 and 11 present an optional embodiment for SAS 100 with respect to the management of multiple client networks, for it will be understood and appreciated that for at least one embodiment, a subset of Users 102 may wish to participate in an augmented reality experience that is different from an augmented reality experience that a different subset of Users 102 is participating in. For example, one group of Users 102 may be participating in an educational augmented reality experience pertaining to anatomy, while another group of Users 102 may be participating in a virtualized scavenger hunt.

As shown in FIG. 10, for at least one embodiment SAS 100 can support a plurality of different client networks 126, such as the exemplary client networks 126A-1126H. The database 438 that provides the data management and storage for SAS 100 so as to maintain the Global Experience State 432 may indeed be structured and arranged to maintain and segregate all of the User augmented environments.

To expand upon the initial suggestion of at least each PCD 104 and the remote computer system 124 with database and other systems comprising SAS 100 being computer systems adapted to their specific roles, FIG. 11 is a high level block diagram of an exemplary computer system 1100 such as may be provided for one or more of the elements comprising at least each PCD 104 and the remote computer system 124 with database and other systems whether provided as distinct individual systems or integrated together in one or more computer systems.

Computer system 1100 has a case 1102, enclosing a main board 1104. The main board 1104 has a system bus 1106, connection ports 1108, a processing unit, such as Central Processing Unit (CPU) 1110 with at least one microprocessor (not shown) and a memory storage device, such as main memory 1112, hard drive 1114 and CD/DVD ROM drive 1016.

Memory bus 1118 couples main memory 1112 to the CPU 1110. A system bus 1106 couples the hard disc drive 1114, CD/DVD ROM drive 1116 and connection ports 1108 to the CPU 1110. Multiple input devices may be provided, such as, for example, a mouse 1120 and keyboard 1122. Multiple output devices may also be provided, such as, for example, a video monitor 1124 and a printer (not shown). For instances where the computer system 1100 is a hand held portable computing system such as a smart phone, computer tablet or other similar device, the display may be a touch screen display—functioning as both an input and output device. As computer system 1100 is intended to be interconnected with other computer systems in the SAS 100 a combined input/output device such as at least one network interface card, or NIC 1126 is also provided.

Computer system 1100 may be a commercially available system, such as a desktop workstation unit provided by IBM, Dell Computers, Gateway, Apple, or other computer system provider. Computer system 1100 may also be a networked computer system, wherein memory storage components such as hard drive 1114, additional CPUs 1110 and output devices such as printers are provided by physically separate computer systems commonly connected in the network.

Those skilled in the art will understand and appreciate that the physical composition of components and component interconnections are comprised by the computer system 1100, and select a computer system 1100 suitable for one or more of the computer systems incorporated in the formation and operation of SAS 100.

When computer system 1100 is activated, preferably an operating system 1128 will load into main memory 1112 as part of the boot strap startup sequence and ready the computer system 1100 for operation. At the simplest level, and in the most general sense, the tasks of an operating system fall into specific categories, such as, process management, device management (including application and User interface management) and memory management, for example. The form of the computer-readable medium 1130 and language of the program 1132 are understood to be appropriate for and functionally cooperate with the computer system 1100.

Changes may be made in the above methods, systems and structures without departing from the scope hereof. It should thus be noted that the matter contained in the above description and/or shown in the accompanying drawings should be interpreted as illustrative and not in a limiting sense. Indeed, many other embodiments are feasible and possible, as will be evident to one of ordinary skill in the art. The claims that follow are not limited by or to the embodiments discussed herein, but are limited solely by their terms and the Doctrine of Equivalents.

What is claimed:

1. A system for synchronizing augmented reality experiences between at least two people, comprising:
a first hand held computing device held out by a first user, the first portable computing device including:
a first camera;
a first touch display;
a first position determining system;
a first transceiver structured and arranged to exchange digital data with at least one remote computer system;
a first processor;
a first non-volatile memory coupled to the first processor having a first instance of an Augmented Reality Application (ARA) presenting processor executable instructions to direct the operation of at least the first camera, the first touch display, the first position determining system, and the first transceiver to obtain from the first camera a first image of the first user's local space and generate a first virtualized local space, the first processor defining a first reference element within the first image and first virtualized local space and initializing the first user's location and orientation with respect to the first reference element;
wherein at least the first virtualized local space, the first reference element and the first user's location and orientation are provided to the at least one remote computer system, the first reference element mapped by the at least one remote computer system to an origin Virtualized Reference Element with the first use's location and orientation indicating a first avatar position;
a second hand held computing device held out by a second user, the second portable computing device including:
a second camera;
a second touch display;
a second position determining system;
a second transceiver structured and arranged to exchange digital data with the at least one remote computer system;
a second processor;
a second non-volatile memory coupled to the second processor having a second instance of the ARA presenting processor executable instructions to direct the operation of at least the second camera, the second touch display, the second position determining system, and the second transceiver to obtain from the second camera a second image of the second user's local space and generate a second virtualized local space, the second processor defining a second reference element within the second image and second virtualized local space and initializing the second user's location and orientation with respect to the second reference element;
wherein at least the second virtualized local space, the second reference element and the second user's location and orientation are provided to the at least one remote computer system, the second reference element mapped by the at least one remote computer system to the origin Virtualized Reference Element with the second use's location and orientation indicating a second avatar position;
wherein the first avatar position relative to the origin Virtualized Reference Element and the second avatar position relative to the origin Virtualized Reference Element is continuously revised and shared as digital information transmission between the at least one remote computer system, the first hand held computing device and the second hand held computing device, the origin Virtualized Reference Element permitting the first hand held computing device to generate and display continuously revised presentations the second avatar in the first virtualized local space and the second hand held computing device to generate and display continuously revised presentations of the first avatar in the second virtualized local space as an augmented reality space.

2. The system of claim 1, wherein the ARA further includes processor executable instructions permitting any user to indicate by touch upon either touch display, the location for a virtual object to be disposed within the augmented reality space.

3. The system of claim 1, wherein the ARA further includes processor executable instructions permitting a reference dimension to be established based on an evaluation of each reference element to an additional reference element in each virtualized local space, the reference dimension permitting common scale of virtualized objects as displayed to each user within the augmented reality space.

4. The system of claim 1, wherein each reference element is a plane.

5. The system of claim 1, wherein each reference element is a corner between planes.

6. The system of claim 1, further including a plurality of second users.

7. The system of claim 5, wherein the plurality of second users are sub-grouped, each sub-group sharing avatar location and orientation information for the members of the subgroup and the first user.

8. The system of claim 1, wherein the exchange first user location and orientation and second user location and orientation information is performed with one or more instances of Photon PUN, Braincloud and Amazon Web Services.

9. The system of claim 1, wherein the generation of the first virtual local space and the second virtual local space is performed with a graphic engine selected from the group consisting of: Unity engine, Apple ARKit, and Google ARcore.

10. The system of claim 1, wherein substantially real time audio communication between the first virtual local space and the second virtual local space is performed with the communication engine Angora.

11. A system for synchronizing augmented reality experiences between at least two people, comprising:
a remote server system having a processor and a digital database, the digital database having a user account for each user utilizing an instance of an application for augmented reality, each user account including at least each user's last known location and orientation with respect to a reference element as defining a virtualized local space for each user as virtualized user digital data;
an Augmented Reality Application (ARA) for installation upon a user's hand-held computing device to be hand held by the user during an augmented reality session, the ARA having at least:
a virtualized local space generator structured and arranged to generate from an image of the user's environment the virtualized local space and the reference element within the image of the user's environment and the virtualized local space;
a virtual object generator structured and arranged to generate at least one virtualized object within the virtualized local space with respect to the virtualized reference element;
a mapper structured and arranged to map the reference element from a local instance of the ARA to the reference element from a remote instance of the ARA, the mapper thereby aligning the virtualized local space of the local instance of the ARA with the virtualized local space of the remote instance of the ARA;
a digital data exchanger structured and arranged to exchange at least virtualized user digital data with at least the remote server system;
wherein a local user desiring an augmented reality experience provides a hand held computing device having at least a processor with memory resources, a camera, a touch display, a position determining system, and a transceiver, an instance of the ARA adapting the processor to generate the virtualized local space and the virtualized reference element, the ARA adapting the processor to obtain from the remote server at least the virtualized user digital data of at least one remote user, the virtual object generator and mapper enabling the processor to generate and provide to the touch display a presentation of the local virtualized local space and the remote virtualized local space as an augmented reality space, the ARA further directing the local user's hand held device to continuously revise the presentation of the augmented reality space as the local user and remote user positions change relative to the mapped virtualized reference elements.

12. The system of claim 11, wherein virtual object generator generates avatars of other remote users based on virtualized user digital data, for users sharing an augmented reality space.

13. The system of claim 11, wherein the ARA further includes processor executable instructions permitting a reference dimension to be established based on an evaluation of each reference element to a second element in each virtualized local space, the reference dimension permitting common scale of virtualized objects as displayed to each user within the augmented reality space.

14. The system of claim 11, wherein each reference element is a plane.

15. The system of claim 11, wherein each reference element is a corner between planes.

16. The system of claim 11, wherein the exchange first user location and orientation and second user location and orientation information is performed with one or more instances of Photon PUN, Braincloud and Amazon Web Services.

17. The system of claim 11, wherein the generation of the first virtual local space and the second virtual local space is performed with a graphic engine selected from the group consisting of: Unity engine, Apple ARKit, and Google ARcore.

18. The system of claim 11, wherein substantially real time audio communication between the first virtual local space and the second virtual local space is performed with the communication engine Angora.

19. The system of claim 11, wherein the ARA further includes processor executable instructions permitting any user to indicate by touch upon either touch display, the location for a virtual object to be disposed within the augmented reality space.

20. The system of claim 11, further including a plurality of remote users.

21. A method for synchronizing augmented reality experiences between at least two people, comprising:
obtaining on a first hand held computing device held out by a first user a first image of the first user's local space;
generating a first virtualized local space based on the first image and defining a first reference element;
determining the first user's location and orientation relative to the first reference element;
sharing at least the first reference element and the first user's location and orientation as virtualized first user digital data with at least one remote server system having a processor and a digital database;
obtaining on a second hand held computing device held out by a second user a second image of the second user's environment;
generating a second virtualized local space based on the second image and defining a second reference element;
determining the second user's location and orientation relative to the second reference element;
sharing at least the second reference element and the second user's location and orientation as virtualized second user digital data with the at least one remote server system;
receiving upon the second hand held computing device from the at least one remote server system the virtualized first user digital data, the second hand held computing device mapping the second reference element to the first reference element to align the second virtualized local space to at least a portion of the first virtualized local space with a first avatar of the first user presented based on the first user's location and orientation;
receiving upon the first hand held computing device from the at least one remote server system the virtualized second user digital data, the first hand held computing device mapping the first reference element to the second reference element to align the first virtualized local space to at least a portion of the second virtualized local space with a second avatar of the second user presented based on the second user's location and orientation;
wherein the first hand held computing device and the second hand held computing device exchange first user location and orientation and second user location and orientation information to continuously revise presentations of the first virtualized local space and the second virtualized local space as an augmented reality space and the first avatar and the second avatar relative to the first reference element.

22. The method of claim 21, wherein each user hand held computing device has at least a processor with memory resources, a camera, a touch display, a position determining system, and a transceiver, an instance of an Augmented Reality Application (ARA).

23. The method of claim 22, wherein the ARA includes at least:
a virtualized local space generator structured and arranged to generate from an image of the user's environment the virtualized local space and the reference element within the image of the user's environment and the virtualized local space;
a virtual object generator structured and arranged to generate at least one virtualized object within the virtualized local space with respect to the virtualized reference element;
a mapper structured and arranged to map the reference element from a local instance of the ARA to the reference element from a remote instance of the ARA, the mapper thereby aligning the virtualized local space of the local instance of the ARA with the virtualized local space of the remote instance of the ARA; and
a digital data exchanger structured and arranged to exchange at least virtualized user digital data with the at least one remote server system.

24. The method of claim 23, wherein the exchange first user location and orientation and second user location and orientation information is performed with one or more instances of Photon PUN, Braincloud and Amazon Web Services.

25. The method of claim 24, wherein the generation of the first virtual local space and the second virtual local space is performed with a graphic engine selected from the group consisting of: Unity engine, Apple ARKit, and Google ARcore.

26. The method of claim 24, wherein substantially real time audio communication between the first virtual local space and the second virtual local space is performed with the communication engine Angora.

27. The method of claim 24, wherein the ARA further includes processor executable instructions permitting any user to indicate by touch upon either touch display, the location for a virtual object to be disposed within the augmented reality space.

28. The method of claim 24, wherein the ARA further includes processor executable instructions permitting a reference dimension to be established based on an evaluation of each reference element to a second element in each virtualized local space, the reference dimension permitting common scale of virtualized objects as displayed to each user within the augmented reality space.

29. The method of claim 24, wherein the second element is a plane.
